(19) United States
(12) Patent Application Publication
(10) Pub. No.: US 2022/0027742 A1
(43) Pub. Date: Jan. 27, 2022

(54) UNSUPERVISED LEARNING

(71) Applicant: Cortica Ltd., Tel Aviv (IL)

(72) Inventor: Karina ODINAEV, Tel Aviv (IL)

(73) Assignee: Cortica Ltd., Tel Aviv (IL)

(21) Appl. No.: 17/443,476

(22) Filed: Jul. 27, 2021

Related U.S. Application Data
(60) Provisional application No. 63/057,255, filed on Jul. 27, 2020.

(51) Int. Cl. G06N 3/08; G06N 3/04; G06K 9/62

(52) U.S. Cl. CPC G06N 3/088; G06K 9/6218; G06N 3/0472

(57) ABSTRACT

A method for an unsupervised training of a neural network, the method may include initializing a neural network that exhibits at least one invariance; performing multiple training iterations until reaching a last training iteration in which a stop condition is fulfilled; wherein each training iteration except the last training iteration comprises: processing a vast number of media units by the neural network to provide media unit signatures; finding that the stop condition is not reached, and changing multiple neural network weights; wherein the stop condition is related to signatures similarities.

### BACKGROUND

Neural networks are used to process There is a growing need to improve neural networks.

### BRIEF DESCRIPTION OF THE DRAWINGS

FIGS. 1-3 illustrate examples of neural networks.

### DESCRIPTION OF EXAMPLE EMBODIMENTS

The specification and/or drawings may refer to an image. An image is an example of sensed information unit. Any reference to an image may be applied mutatis mutandis to a sensed information unit. The sensed information unit may be applied mutatis mutandis to a natural signal such as but not limited to signal generated by nature, signal representing human behavior, signal representing operations related to the stock market, a medical signal, and the like. The sensed information unit may be sensed by one or more sensors of at least one type—such as a visual light camera, or a sensor that may sense infrared, radar imagery, ultrasound, electro-optics, radiography, LIDAR (light detection and ranging), a non-image based sensor (accelerometers, speedometer, heat sensor, barometer) etc.

The sensed information unit may be sensed by one or more sensors of one or more types. The one or more sensors may belong to the same device or system—or may belong to different devices of systems.

Various examples refer to distances—for example a distance between media unit signatures, a distance between clusters, and the like. The distance between clusters may be a distance between cluster signatures. Any distance may be a similarity feature. If a first signature is closer to a second signature in relation to a third signature—then the first signature is more similar to the second signature and less similar to the third signature. Each signature may include multiple elements and the similarity between signatures may provide an indication of how many elements are shared between the signatures. The elements may represent features and different signatures differ from each other by one or more features. A cluster signature represents features that are shared between at least a certain number or certain percent (for example 10, 20, 30, 40, 50, 60, 70, 80, or 90 precent) of its members. The value of the certain number or the certain percent may be determined in any manner—for example by providing any tradeoff between false matches and missed true matches. For example—assuming that a cluster includes a first number (N1) of media unit signatures and each media unit signature includes (in average) a second number (N2) of elements. In this case the signatures of the clusters may include up to N1×N2 different features. Nevertheless—different sets of signatures of a cluster share at least a predefined number of shared features—and thus the cluster signature may include a third number (N3) of features—whereas N3 is much smaller than N1×N2.

The sensed information may be processed by a processor. The processor may be a processing circuitry. The processing circuitry may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits.

There may be provided a neural network (NN)—(for example a convolution neural network (CNN) or another neural network (ANN)) that may include a number of layers that are connected to each other—fully connected or partially connected.

The NN may be adapted (through training and the like) to a certain types of content—for example, X-ray sensed information, regular camera sensed information, multispectral camera, radar, 2D data (e.g. financial series, time series), audio signals and the like.

The NN may be initially set with initial weights—can be determine in any manner—for example in a random manner.

It is desired that the NN will provide similar outputs (for example similar signatures or sub-signatures) for similar medial units and provide—different signatures for different media units.

The initial learning process may be totally unsupervised—and may be aimed to order signatures of media units on a N dimension space (for example sphere, N being an integer that exceeds one)—for example more similar media units will be closer to each other in the N dimension space.

The NN may include many neurons—for example 10,000,000 neurons—with initial randomly assigned weights.

The learning process may include (a) feeding media units to the NN, (b) generating signatures by the NN—till obtaining many (for example at least 1,000,000 signatures), and (c) performing an optimization (or a sub-optimal process) of distances between signatures—and assign weights that will lead to the optimal or sub-optimal distances.

Yet another learning process may include a more supervised learning process—in which the media units are still untagged—but the learning process receives defined operators—that should be robust in advance—lighting, orientation—operations that are similar are close to each other. One example of doing it is providing, for example 2 orientations of the same object in image and optimize the weights so both will give the same signature.

The more supervised learning process may includes (a) feeding media units to the NN, (b) generating signatures by the NN—till obtaining many (for example at least 1,000,000 signatures), and (c) performing an optimization (or a sub-optimal process) of distances between signatures—and assign weights that will lead to the optimal or sub-optimal distances.

In any learning process—the robustness may be obtained by feeding the NN with a large array of media units—generate signatures by the NN, cluster the signatures to provide clusters (clustering may be without constraints or may be constrained—for example by number of signatures per cluster, by number of clusters, by defining cluster rules—how to determine that a signature belongs to the cluster, defining required differences between clusters, and the like). The clusters may be further divided to sub-clusters. Metadata may be added to clusters and/or sub-clusters of any level.

There may be provided solution that may provide a NN that is (a) robust to small changes on a pixel level, and (b) robust to movements inside the signal (=translation invariant).

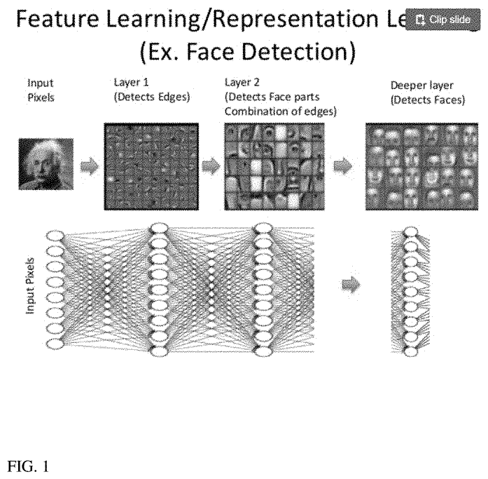

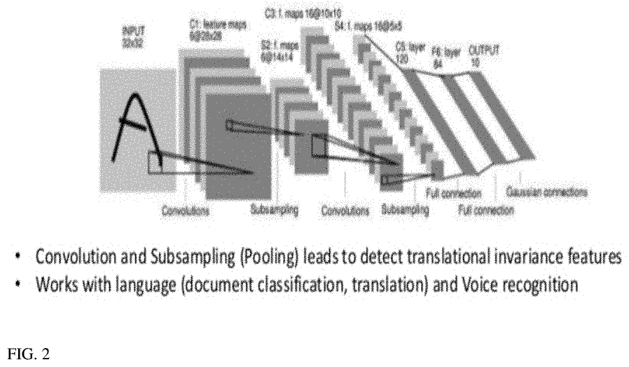

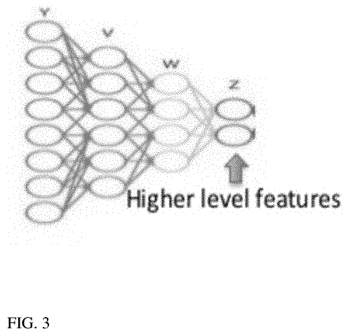

Item (a) may be achieved by providing a NN that (i) supports spatial dimension reduction (such as pooling, convolution, projection from high to low receptive fields), and may be built bottom up, from small and simple patterns to more and more complex. FIGS. 1 and 2 illustrate an example that fulfills item (a). FIG. 3 illustrates building a NN bottom up. Referring to FIG. 2—it illustrates max pooling. (Just an example of a network implementation that provides robustness to translation, rotation etc, as described in several lines below ((e.g invariant translation, rotation invariant, etc))) The idea of complex cell layer is to “pool” a set of simple cells and acquire the same data from those simple cells (e.g invariant translation, rotation invariant, etc). Basically, where small movements in a certain layer will be retranslated to the same output in the next layer. In FIG. 2—assuming that an input image has 10 by 10 pixels, and there is a one-pixel nose at coordinates (4,5) and one-pixel mouth at coordinates (6,5). The process may define a pattern that a mouth beneath a nose compose a face. Max-pooling maps the 10×10 picture to a 5×5 picture. Thus the nose at (4,5) is mapped to (2,3) and the mouth at (6,5) is mapped to (3,3) in the smaller picture. Now the process takes another picture with a one-pixel nose at (4,6) and one-pixel mouth at (6,6), i.e. a translation of one pixel to the right. By using Max-pooling, they are mapped to (2,3) and (3,3), which is still classified at a face. And this ability is called “translation invariance”. Actually, max-pooling not only creates translation invariance, but also—in a larger sense—deformation invariance.

Item (b) may be achieved by using a NN that is built on a repetitive manner (or scanning technique of patches, i.e. dividing the image into patches, and looking for the same patterns in every patch).

A NN that achieves (a) and (b) should undergo a weight optimization (or sub-optimal setting) process to achieve a predefined rule—for example maximal average distance between the signatures.

The NN may be generated by: (a) generate a NN with random weights, and preform an iterative process—until reaching a predefined rule: (b) feeding the NN with multiple media units, (c) generate signatures by the NN, (d) measure a distance between each pair of signatures, (e) calculate an average of distances, (f) change weights, (g) check whether predefined rule was reached—if not jump to (b). The predefined rule may be a maximal value of the average distance, or system entropy. Other predefined rules may be applied. Example of a weights changing algorithms can be moving weight for a certain node to value+/−1. This can be done sequentially for each node, or certain groups can be changed together.

FIG. 4 illustrates a method 100 for unsupervised training a neural network.

Method 100 may start by step 110 of initializing a neural network that exhibits at least one invariance.

The initializing can be done by assigning weight in any manner. For example—random, pseudo random, according to one or more rules—and the like.

The neural network may exhibit at least one invariance in the sense that its output (for example media unit signatures) will be the same regardless of at least one variance—such as scale-invariance (examples of scale-invariance include the scale invariant feature transform (SIFT) algorithm), transform invariance, rotation invariance and the like.

In method 100 the at least one invariance is provide based on the architecture of the neural network, but is should not be provided by a supervised process.

An example of a scale invariant neural network is the scaleinvariant convolutional neural network (SiCNN) suggested by Xu et al in “Scale-Invariant Convolutional Neural Networks”, arXiv:1411.6369v1 [cs.CV] 24 Nov. 2014. Other example of scale invariant neural networks are illustrated above—including a neural network that is built in a repetitive manner.

An example of a translation invariant neural network is the convolutional neural network (CNN).

Step 110 may be followed by step 120 of performing multiple training iterations until reaching a last training iteration in which a stop condition is fulfilled.

The stop is related to similarity between signatures (for example media unit signatures and/or cluster signatures (if such signatures are generated).

Each training iteration except the last training iteration includes (a) processing a vast number of media units by the neural network to provide media unit signatures; the vast number may exceed 100,000, 500,000, 1,000,000, 2,000,000, 10,000,000, 200,000,000, and the like, (b) finding that the stop condition is not reached, and (c) changing multiple neural network weights; wherein the stop condition is related to signatures similarities.

The last training iteration may include processing the vast number of media units by the neural network to provide media unit signatures, and finding that the stop condition is reached.

The signatures similarities (calculated to determine the fulfillment of the stop condition) may be similarities between the media unit signatures.

According to another example—each training iteration except the last training iteration may include (a) processing the vast number of media units by the neural network to provide the media unit signatures; (b) clustering the media unit signatures to provide clusters of media unit signatures; (c) generating cluster signatures, wherein a cluster signature is indicative of similarities between media unit signatures of the cluster; and (d) finding that the stop condition is not reached, and changing multiple neural network weights; wherein the signatures similarities are related to one or more similarities between the cluster signatures.

The stop condition may be a maximal distance between cluster signatures. This may be a maximal sum of all distances, a maximal value of an average distance (or at least an average distance that exceeds a predefined value). It should be noted that the distance represent the similarity—common features.

A stop condition that is based on similarity between cluster signature require less calculation than basing the stop condition on similarity between media unit signature and may also be more accurate—as each cluster signature already embeds information about many media unit signature that share some features in common (as they belong to the same cluster). Examples of clustering, media unit signatures are illustrated in US patent application publication number 20200134327 which is incorporated herein by reference.

FIG. 4 illustrates an example of a method 200 for semi-supervised training of a neural network.

The term “semi-supervised” refers to the fact that the training is done on a first group of media units and a second group of media unit, while the stop condition is related to the signatures of the first media units. The number of the first media units may be a fraction (for example less than 1, 0.1, 0.01, 0.001, 0.0001, 0.00001, 0.000001, 0.0000001, 0.00000001, and even less) than the number of the second media units. For example—there may be million or more second media units and less than 10, 20, 30, 40, 50, 60, 80, 90, 100 first media units.

The first media units may include one or more sets. Each set include media units of the same object (or objects) at different conditions—for example different image acquisition parameters (for example illumination, angle of view), different orientations, different scales, and the like. The stop condition forces the signature of media unit of a certain set to be equal to each other. This provide an invariance to the neural network.

Method 200 may start by step 210 of initializing a neural network. The neural network may exhibit at least one invariance that is not provided by the training process.

Step 210 may be followed by step 220 of performing multiple training iterations until reaching a last training iteration in which a stop condition is fulfilled.

Each training iteration except the last training iteration may include (a) processing the first group of media units and the second group of media units by the neural network to provide first media unit signatures and second media unit signatures. The second group of the media units may include a vast number of media units. The first group of media units comprises one or more set, each set captures one or more objects at different conditions—for example different image acquisition parameters (for example illumination, angle of view), different orientations, different scales, and the like, (b) finding that the stop condition is not reached, and (c) changing multiple neural network weights. The wherein the stop condition is related to a relationship between the first media unit signatures.

The stop condition may be that for east set of the first media units—the first media units signatures are equal (or similar) to each other.

The stop condition may be indifferent to a relationship between the second media unit signatures.

Method 200 may process in real time the vast number of second media units without applying constrained on the second media unit signatures—thus using the benefits of unsupervised training—which is the ease and cost effectiveness of unsupervised training—that does not even require tagging. The stop rule is related to the first media units—and provides one or more invariances. The media units of the set may be sensed by a sensor, generated by a computerized process, and the like.

Method 100 and/or method 200 may be executed by a computerized system that may include one or more processors.

It is appreciated that software components of the embodiments of the disclosure may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the disclosure. It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub combination. It will be appreciated by persons skilled in the art that the embodiments of the disclosure are not limited by what has been particularly shown and described hereinabove. Rather the scope of the embodiments of the disclosure is defined by the appended claims and equivalents thereof.

What is claimed is:

1. A method for an unsupervised training of a neural network, the method comprises:
initializing a neural network that exhibits at least one invariance;
performing multiple training iterations until reaching a last training iteration in which a stop condition is fulfilled;
wherein each training iteration except the last training iteration comprises:
processing a vast number of media units by the neural network to provide media unit signatures;
finding that the stop condition is not reached, and changing multiple neural network weights; wherein the stop condition is related to signatures similarities.

2. The method according to claim 1 wherein the last training iteration comprises processing the vast number of media units by the neural network to provide media unit signatures and finding that the stop condition is reached.

3. The method according to claim 1 wherein the signatures similarities are similarities between the media unit signatures.

4. The method according to claim 1 wherein the each training iteration except the last training iteration comprises:
processing the vast number of media units by the neural network to provide the media unit signatures;
clustering the media unit signatures to provide clusters of media unit signatures;
generating cluster signatures, wherein a cluster signature is indicative of similarities between media unit signatures of the cluster; and
finding that the stop condition is not reached, and changing multiple neural network weights; wherein the signatures similarities are related to one or more similarities between the cluster signatures.

5. The method according to claim 4 wherein the stop condition is a maximal distance between cluster signatures.

6. The method according to claim 4 wherein the stop condition is a maximal average distance between cluster signatures.

7. The method according to claim 4 wherein the stop condition is an average distance between cluster signatures that exceeds a predefined threshold.

8. The method according to claim 1 wherein the at least one invariance comprises at least one of scale invariance and translation invariance.

9. A method for a semi-supervised training of a neural network, the method comprises:
initializing a neural network;
performing multiple training iterations until reaching a last training iteration in which a stop condition is fulfilled;
wherein each training iteration except the last training iteration comprises:
processing a first group of media units and a second group of media units by the neural network to provide first media unit signatures and second media unit signatures; wherein the second group of the media units comprises a vast number of media units; wherein the first group of media units captures an object at different illumination and translation conditions;
finding that the stop condition is not reached, and changing multiple neural network weights; wherein the stop condition is related to a relationship between first media unit signatures of one or more sets of the first media units.

10. The method according to claim 9 wherein the stop condition is that all first media units signatures are equal to each other.

11. The method according to claim 9 wherein the stop condition is that all first media units signatures are similar to each other.

12. The method according to claim 9 wherein the stop condition is indifferent to a relationship between the first media unit signatures.

13. The method according to claim 9 wherein the at least one invariance comprises at least one of scale invariance and translation invariance.

14. A non-transitory computer readable medium that stores instructions for: initializing a neural network that exhibits at least one invariance; performing multiple training iterations until reaching a last training iteration in which a stop condition is fulfilled; wherein each training iteration except the last training iteration comprises: processing a vast number of media units by the neural network to provide media unit signatures; and finding that the stop condition is not reached, and changing multiple neural network weights; wherein the stop condition is related to signatures similarities.
